(19) United States
(12) Patent Application Publication
(10) Pub. No.: US 2017/0304143 A1
(43) Pub. Date: Oct. 26, 2017

(54) MASSAGE TOY WITH WITH INTEGRATED MOVEABLE BALLS

(71) Applicant: Fun Factory GmbH, Bremen (DE)

(72) Inventor: Servet TERKES, Bremen (DE)

(21) Appl. No.: 15/517,945

(22) PCT Filed: Oct. 8, 2015
(86) PCT No.: PCT/EP2015/073300

§ 371 Date: Apr. 7, 2017

(30) Foreign Application Priority Data
Oct. 8, 2014 (DE) 20 2014 008 093.3
Dec. 18, 2014 (DE) 20 2014 010 029.2

(51) Int. Cl. A61H 19/00; A61H 15/00; A61H 23/00

(52) U.S. Cl. CPC A61H 19/44; A61H 2201/0107; A61H 2015/0064; A61H 2015/0071; A61H 2023/002

(57) ABSTRACT

The invention relates to a massage toy, in particular a dildo or vibrator, comprising a substantially cylindrical base member which is made of a supple material. According to the invention, the base member has at least one inner cavity in which a freely movable inertial member is arranged. The invention further relates to the use of a love ball and to a method of producing a massage toy.

### BACKGROUND

The invention relates to a massage toy, in particular a dildo or vibrator or the like, comprising a substantially cylindrical base member which is made of a supple material. The invention further relates to the use of a love ball, in particular a Smartball® (Smartballs® is a registered trademark of the applicant), and to a method of producing a massage toy.

### BRIEF SUMMARY

Massage toys of the kind initially specified are known in many variants from the prior art. A basic distinction is made between passive and active toys, passive toys generally being called dildos, and active toys, in particular motor-driven toys, being called vibrators. Vibrators generally have a battery or a rechargeable battery and a motor which drives an unbalanced mass so that a base member of the toy, or a portion of it, is made to vibrate and can thus be used for stimulation or massage. One disadvantage in this regard is the limited capacity of the battery or rechargeable battery.

Dildos, in contrast, are generally passive and do not have an electrical drive. They mostly have a cylindrical base member which substantially imitates the shape of the erect male sex organ in many cases. Many also have a broader section or grip portion with which the dildo can be handled, the broader section also serving to limit the depth of penetration into a body orifice. Dildos for female couples are also known, which mostly have two opposite cylindrical base members arranged coaxially with or at an angle to each other. The present invention relates to the species of passive, non-driven dildos.

Although many different dildos are already known on the market, there is still a need to specify dildos having improved characteristics regarding their suitability for massage, for stimulation, in particular for stimulation of female sex organs, in particular without an electrical drive.

It is therefore an object of the present invention to specify massage toys of the kind initially specified, and a use of love balls and a method of producing same, which are improved in respect of the aforementioned characteristics.

This object is achieved, in the case of the massage toy initially specified, by the base member having at least one inner cavity in which a freely movable inertial member is arranged.

The inertial member can move inside the cavity. The movement of the inertial member inside the cavity causes the supple base member to move and/or vibrate, with improved stimulation being the result. Due to the inertia of the inertial member, it may collide against an inner wall of the cavity when moved accordingly, and when it comes into contact with the wall it transfers impact energy to the base member, which is made to vibrate as a result. The inertial member may also roll or slide along the wall of the cavity, thus exerting a centrifugal force on the base member when the toy is moved accordingly. The centre of gravity of the base member also moves due to the inertial member moving inside the cavity, which likewise results in substantially improved stimulation. The invention makes it possible to improve stimulation substantially provided by a dildo, without requiring a motor-driven mass as in conventional vibrators. Simply moving the dildo manually causes the inertial member to move and to transfer energy to the base member.

The base member is substantially cylindrical and is preferably shaped approximately like an erect male sex organ. Substantially cylindrical relates here to the basic shape of the base member and also includes slightly undulating external contours and slightly curved shapes. The base member itself is preferably formed completely from a supple material which is preferably medical grade and skin-friendly.

The inertial member is preferably rigid. The inertial member is able to move inside the cavity, shift the centre of gravity and transfer energy (impact energy, for example) to the base member. A rigid inertial member, in particular, is suitable for that purpose. The inertial member is preferably of such rigidity that it itself absorbs as little of the impact energy as possible when colliding with an inner wall of the cavity, but transfers that energy as fully as possible to the base member. Stimulation is particularly good as a result. For less intensive stimulation, it may also be preferred to use a fluid instead of the inertial member, the volume of said fluid being less than the interior volume of the cavity, in particular 50% or less thereof.

According to a first preferred embodiment of the invention, the base member has at least one inner cavity. In another preferred embodiment, it has, two, three, or more inner cavities, in each of which a freely movable inertial member is arranged. In a preferred embodiment, the number of distinct inner cavities is set at three. Stimulation is further improved as a result. Three cavities can be advantageously provided when the base member has a preferred axial length ranging from approximately 17 cm to 22 cm. It is thus possible and preferable to provide a total of six cavities in dildos which have two opposite base members and which are intended for female couples. The cavities may all be formed identically, or they may differ from one another. For example, it may be preferable to make one cavity at the front axial end of the base member larger than at the rear axial end. The converse configuration is also conceivable and, depending on actual usage, may also be preferred.

According to another preferred embodiment, the inertial member is round. It is particularly preferable that the inertial member is spherical in shape. A round shape, in particular a spherical shape, is a particularly simple shape that provides advantages for the production process, and such an inertial member can roll inside the cavity and thus, when the toy is moved accordingly, can also act as an unbalanced mass and also transfer impact energy.

It is particularly preferred that the inner cavity has an inner profile having a larger diameter than the inertial member, so that the inertial member can move freely inside the cavity. The cavity preferably has an inner diameter that is larger everywhere than the largest diameter of the inertial member. This allows the inertial member to move particularly freely inside the cavity without any jamming or the like.

In one preferred development of the invention, the diameter of the cavity exceeds the diameter of the inertial member by an amount ranging from 2 mm to 20 mm, preferably 3 mm to 15 mm, particularly preferably from 4 mm to 10 mm, and even more preferably from approximately 6 mm to 10 mm.

It is further preferred that the diameter of the cavity exceeds the diameter of the inertial member by an amount ranging from 10% to 100%, preferably 10% to 50%, more particularly from 10% to 70%, preferably 20% to 60%, and particularly preferably from 15% to 30% or from 30% to 50%. With such values and ratios, a certain amount of clearance is provided between the inertial member and an inner wall of the cavity, which is sufficient to transfer not only a preferred impact energy, by providing a sufficiently long path for accelerating the inertial member, but also to transfer a vibration due to the inertial member rolling inside the cavity and shifting the centre of gravity of the base member.

According to a preferred development of the invention, the inertial member has a volume V1 and the cavity has an inner volume V2, and a ratio of volume V1 to V2 in a range from 0.1 to 1.0, preferably from 0.1 to 0.6, and particularly preferably from 0.2 to 0.5. In that case also, a certain amount of clearance is provided between the inertial member and an inner wall of the cavity, which is sufficient to transfer not only a preferred impact energy, by providing a sufficiently long path for accelerating the inertial member, but also to transfer a vibration due to the inertial member rolling inside the cavity and shifting the centre of gravity of the base member.

It is preferable that the inertial member has a mass m1, that the toy has a mass m2, and that the ratio of mass m1 to m2 is in a range from 0.01 to 1, preferably from 0.01 to 0.5, particularly preferably from 0.1 to 0.3 and most preferably approximately 0.2. Such a ratio of the masses produces an intrinsically dynamic effect, and the toy moves because of a transmission of impulses from the inertial member to the body of the toy. When there is a plurality of cavities with a respective plurality of inertial members, mass m1 pertains to the total masses of all the inertial members.

In another preferred embodiment, the cavity has an inner profile which is substantially spherical. In yet another preferred embodiment, the cavity has an inner profile which is substantially ellipsoidal. Both profiles, spherical and ellipsoidal, are particularly preferred when the inertial member likewise has a round shape, for example a spherical or ellipsoidal shape. In this way, the inner profile of the cavity matches an external profile of the inertial member, and the inertial member can roll inside the cavity and thus transfer impact energy, or energy due to centrifugal forces, to the base member and shift the centre of gravity of the base member. Matching profiles also have the advantage that less noise is produced, which is likewise preferred. It is desirable that such a toy does not produce any rattling or clicking noises when in use, but can be operated with as little noise as possible.

According to another preferred embodiment of the invention, the cavity has a principal axis, and the principal axis extends substantially coaxially with a central axis of the base member. According to this embodiment, it is preferable that the cavity is substantially ellipsoidal. A path travelled by the inertial member in the direction of the central axis of the base member is greater as a result than a path of radial movement relative to the base member, thus providing a further improvement in stimulation with the toy. Any shift of the centre of gravity along the central axis is greater than any shift in the radial direction relative to the base member, and any transfer of impact energy in the former direction is also greater. This corresponds more closely to a natural movement, thus resulting in improved stimulation.

A particularly preferred embodiment is one in which at least one rigid enclosure is arranged in and completely enclosed by the base member, and in which said enclosure defines the cavity. The enclosure thus encloses a hollow space which forms the cavity, and an inner surface of the enclosure defines the profile of the cavity. Since the base member is made of a supple material, providing a rigid enclosure around the inertial member allows energy to be transferred particularly well from the inertial member to the base member. The energy, for example impact energy, is not absorbed straight away by the material of the base member, but is initially transferred to the rigid enclosure, which then transfers the energy along its entire outer surface, which is entirely surrounded by the base member.

It is further preferred that the enclosure is formed of two half-shells. This is a particularly simple way of forming the rigid enclosure and reduces costs when assembling and producing the toy. The enclosure can thus be produced as an injection-moulded part, for example, and can enclose the inertial member by joining the two half-shells of the enclosure.

According to another preferred embodiment, ribs are formed at an inner wall enclosing the cavity. The ribs preferably protrude in the direction of the cavity, and in such a case the end portions of the ribs facing inwards define an enveloping surface which defines the profile of the cavity. A contact surface between the inertial member and the wall or enveloping surface of the cavity is reduced by the ribs, which also reduces any noise produced when handling the toy. If, as in any of the embodiments described in the foregoing, an enclosure which defines the cavity is provided in the base member, the ribs are preferably moulded integrally on the enclosure.

According to one particularly preferred embodiment of the invention, at least one love ball, preferably a Smartball®, is arranged in the base member, and the enclosure of the love ball defines the cavity and the inner ball of the love ball forms the inertial member. The love ball is preferably a Smartball®, so called, such as the one developed, produced and sold by the present applicant, in particular under article numbers EAN 4032498331652 and EAN 4032498333083. Such love balls or Smartballs® or B-Balls are provided to strengthen and invigorate the muscles of the pelvic floor and have a movable ball inside that stimulates the pelvic floor muscles and trains them. Such Smartballs® are particularly suitable for integration in the base member of the toy and result in a toy with which a particularly preferred form of stimulation can be achieved.

In another preferred embodiment, the base member is made of a silicone, preferably of a medical grade silicone. Silicone is particularly suitable because it is pleasantly soft, thus producing particularly pleasurable stimulation when using the toy. Above all, the base member is very hugging due to its elastic surface structure, which allows its outer profile to adjust to body parts massaged or stimulated by means of the toy.

In another preferred embodiment, the base member is slightly widened radially externally in the region of the cavity. If a plurality of cavities are provided, the base member is preferably slightly widened in the region of every cavity. This gives the base member a slightly undulating external structure. Slight constrictions on the member are thus provided between the cavities. The undulating structure improves the stimulating capabilities of the toy. The thickness of the base member wall around the cavity is preferably in a range between 2 mm and 15 mm, preferably between 3 mm and 10 mm. Energy can be transferred particularly well as a result from the inertial member and from the enclosure to the base member and outwards. If an enclosure is provided around the cavity, the aforementioned values relate to a wall thickness of the base member around the enclosure.

According to another aspect of the invention, the object referred to at the outset is achieved by using a love ball. While any love ball is accepted, the use of a Smartball®, which is a particular type of love ball, is preferred. The love ball (or Smartball®) is used for integration in a base member of a dildo. This provides the advantages described in the foregoing, so reference is made in full to the description above.

According to another aspect of the invention, the object referred to at the outset is achieved by a method of producing a massage toy, in particular according to any one of the preferred embodiments of a massage toy as described in the foregoing, by casting at least one love ball, in particular Smartballs®, in a silicone material to form a base member. This is done by arranging the love ball, in particular a Smartball®, in a casting mould and filling the casting mould with silicone in such a way that the love ball, in particular a Smartball®, is completely enclosed by the silicone material. One, two, three or more love balls are preferably provided. For the other preferred variants of the massage toy produced in this manner, reference is made to the preferred embodiments of a massage toy as described above, and in this regard to the description above.

The invention can also be constructed in the form of a vibrator. In this case a motor-driven source of vibration or motion is provided, in which the source of vibration or motion ensures that the inertial member inside the cavity is excited, that is to say is moved. This can be done by having a recess or open cavity in the base end in which a vibrating member can be inserted, or by casting a vibration capable motor in the base. Such a vibrator will also have an appropriate source of energy, for example a battery.

### BRIEF DESCRIPTION OF THE SEVERAL VIEWS OF THE DRAWINGS

The invention shall now be described in more detail with reference to an embodiment and with reference to the attached drawings, in which

FIG. 1 shows a side elevation view of a massage toy;

FIG. 2 shows a perspective front view of the massage toy shown in FIG. 1;

FIG. 3 shows a partial cutaway view of the massage toy, showing three cavities enclosed by enclosures; and

FIG. 4 shows an opened enclosure containing an inertial member.

### DETAILED DESCRIPTION

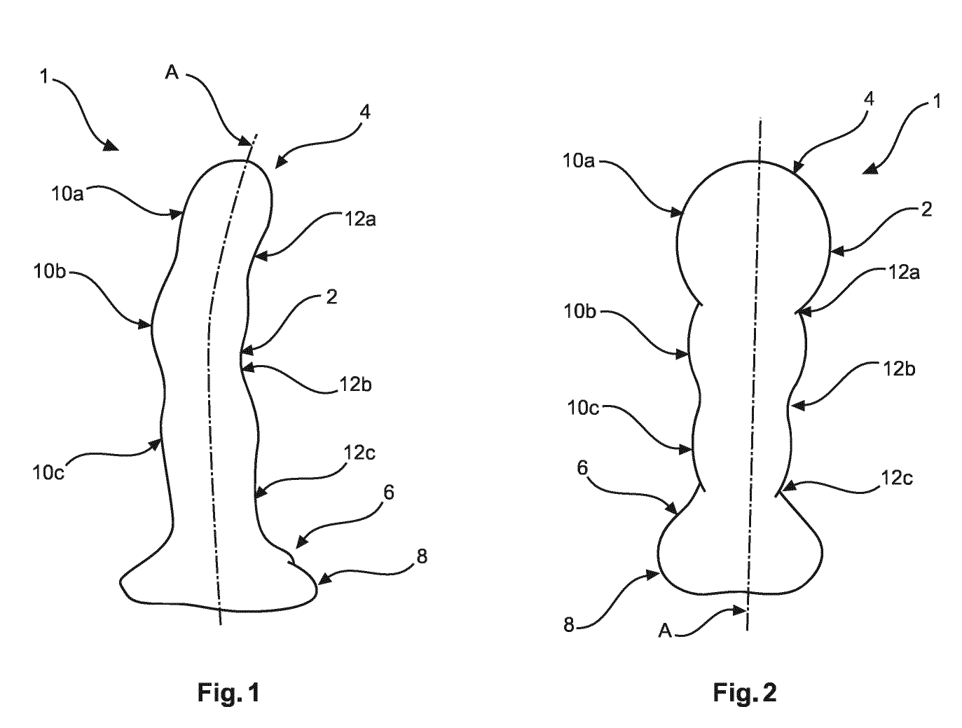

According to FIG. 1, a massage toy 1 has a base member 2. Base member 2 is substantially cylindrical and has a central axis A that is slightly curved in this embodiment. Base member 2 is made of a supple, medical-grade silicone material and is therefore elastic as a whole, so it can also be straightened up in such a way that central axis A is straight. Base member 2 also has a front axial end 4 and a rear axial end 6. At the rear axial end 6, a flange-like radial extension 8 is provided which serves to limit the axial depth of penetration of base member 2 from the front axial end 4 to the rear axial end 6. The flange-like radial extension 8 also serves as a grip or harness for handling toy 1.

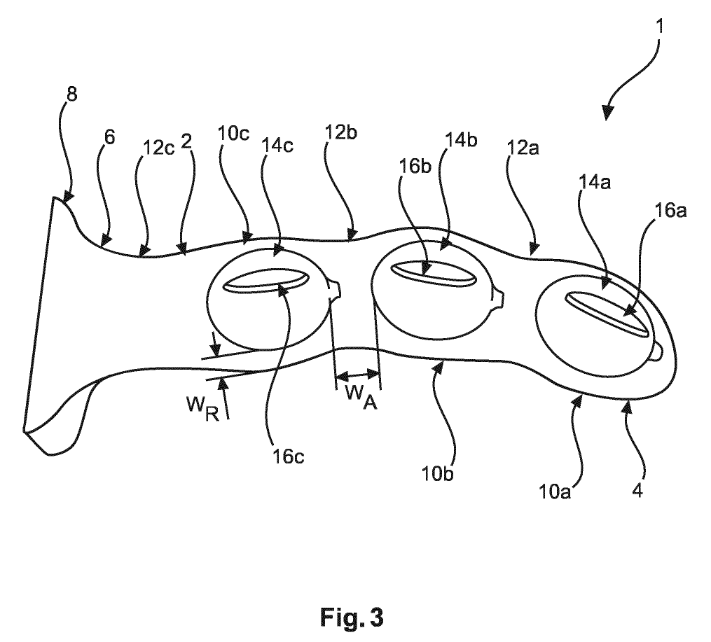

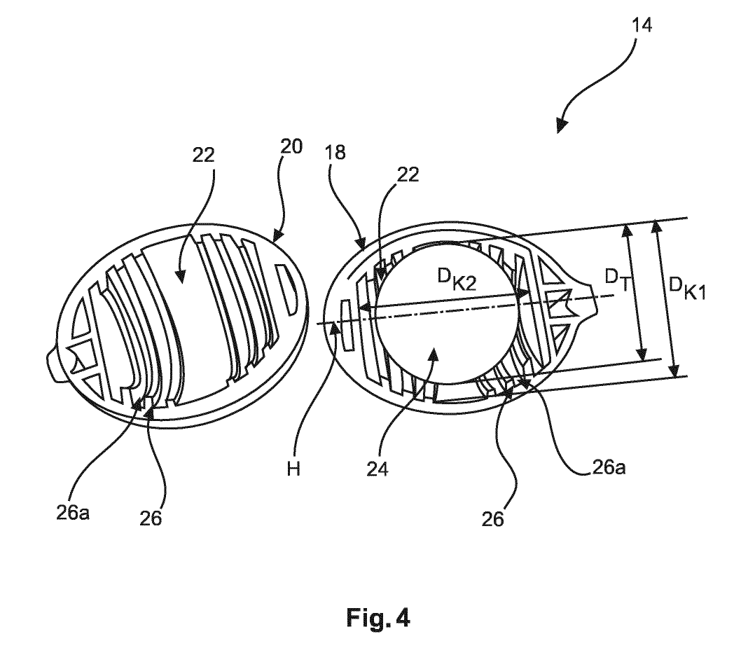

In this embodiment of the invention, base member 2 has three cavities 22 (see FIGS. 3 and 4), so three radial bulges 10a, 10b, 10c and three radial constrictions 12a, 12b, 12c corresponding to radial bulges 10a, 10b, 10c can be seen on base member 2, with the result that base member 2 has a slightly undulating shape on the whole. This configuration can also be seen in the perspective view shown in FIG. 2.

FIG. 3 shows a partial cutaway view through toy 1 along axis A. The cut is only partial, because cavities 22 themselves as well as inertial member 24 are not visible (see FIG. 4 in that regard). In this embodiment, cavities 22 are defined by enclosures 14a, 14b, 14c, which are not cut through in FIG. 3. In this embodiment, three enclosures 14a, 14b, 14c are provided, inside each of which an inertial member 24 (cf. FIG. 4) is arranged. In combination with inertial members 24 arranged therein, enclosures 14a, 14b, 14c form a Smartball®, of the kind developed, produced and sold by the present applicant. Smartball® is a commercial product that has been sold on the open market for a few years, and thus is well known in the art and need not be described further. In the embodiment shown in FIG. 3, three Smartballs® are provided accordingly in base member 2. In one version, each Smartball® is fully isolated from the others. In other versions, a small cord can connect adjacent Smartballs® to each other.

The ratio of the total mass of all three inertial members 24 to the total mass of toy 1 is 0.07 to 1.0 in this embodiment. As can be seen from FIG. 3, radial bulges 10a, 10b, 10c are provided in the regions in which enclosures 14a, 14b, 14c are arranged in base member 2. Enclosures 14a, 14b, 14c have a substantially ellipsoidal or egg-shaped external profile and are spaced apart from each other by a gap WA. Enclosures 14a, 14b, 14c are not interconnected, even if that may be provided in other embodiments. In this embodiment, one enclosure 14a is provided in the region of base member 2 that forms the glans of the male sexual organ, and two enclosures 14b, 14c are provided in the region of base member 2 which constitutes the shaft in a male sex organ. The gap WA between two adjacent enclosures 14b, 14c and 14a, 14b is chosen so that sufficient material is present there to allow flexion of base member 2. A slight constriction is additionally provided on the base member in regions 12a, 12b, 12c. This results in a preferred external profile, as already described above with reference to FIGS. 1 and 2. Each enclosure 14a, 14b, 14c is surrounded radially externally by a wall of base member 2 that is WR thick (marked only for enclosure 14c). Wall thickness WR is selected to allow energy transfer from enclosure 14a, 14b, 14c to base member 2 and outwardly from the latter, and so that absorption by the silicone material of base member 2 is not too great. Due to enclosures 14a, 14b, 14c being rigid and preferably made of a non-elastic plastic, base member 2 acquires a certain degree of stability and resistance to pressure, which is preferable for stimulation.

A rib 16a, 16b, 16c which serves to produce an improved connection between the silicone material of base member 2 and enclosure 14a, 14b, 14c is provided on a radially external surface of enclosure 14a, 14b, 14c.

Each enclosure 14 has a cavity 22 on the inside. Cavity 22 and inertial member 24 can be seen in more detail in FIG. 4. FIG. 4 also shows an opened enclosure 14, with the two half-shells 18, 20 forming enclosure 14 being dissembled. The interior of enclosure 14 defines a cavity 22 in which an inertial member 24 is arranged. In each of its half-shells 18, 20, enclosure 14 has inwardly protruding ribs 26 extending circumferentially about a main axis A (only one rib in each is marked with a reference sign), and the radially inwardly protruding end portions 26a of ribs 26 jointly define an enveloping profile that forms the profile of cavity 22.

In this embodiment, inertial member 24 is in the form of a ball, in particular in the form of a ball made of a metal material, a hard plastic material, a ceramic material or a wooden material, preferably a material with a relatively high density, and preferably with a higher density than the density of base member 2.

Cavity 22 has a basic shape that is substantially ellipsoidal, with a principal axis H. When the enclosure is integrated (cf. FIG. 3), said principal axis H is oriented in such a way that it extends substantially coaxially with axis A of the base member.

As can also be seen from FIG. 4, inertial member 24 is significantly smaller than cavity 22 and therefore has a smaller diameter than the latter. Diameter DT of inertial member 24 is smaller than the radial diameter DK1 of cavity 22 and smaller than the diameter DK2 of cavity 22 measured along principal axis H. More specifically, diameter DK1 is approximately 30% larger than diameter DT, and in this embodiment DK2 is approximately 45% larger than diameter DT. Here, diameter DK1 is approximately 30.5 mm, while diameter DK2 is approximately 26.4 mm. The outer diameter of enclosure 14 (in the region of the secondary axis of the ellipse) is approximately 30 mm to 34 mm. This allows inertial member 24 to roll along end portions 26a of the ribs inside cavity 22 and to push against them, thus having different effects on base member 2. Inertial member 24 can collide with enclosure 14 if there is any jolting movement, thus transmitting impact energy to base member 2, and if there is rotating or circular movement of base member 2, inertial member 24 can roll on ribs 26 inside enclosure 14, thus transferring a centrifugal force onto the enclosure, as a result of which a vibration is transferred to base member 2. By simple displacement of inertial member 24 inside enclosure 14, it is also possible to continuously alter the center of gravity of base member 2. A particularly pleasant massage or stimulation is produced by all three types of movement when toy 1 is used for massage or stimulation.

In this embodiment, the weight of enclosure 14, including inertial member 24, is in a range between 29 grams and 35 grams, the weight of the inertial member being approximately 20 grams.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A massage toy, comprising:
a substantially cylindrical base member which is made of a supple material, wherein the base member has at least one inner cavity in which a freely movable inertial member is arranged.

2. The toy according to claim 1, wherein the base member has at least, two, inner cavities, in each of which a freely movable inertial member is arranged.

3. The toy according to claim 1, wherein the inertial member is round.

4. The toy according to claim 1, wherein the inertial member is substantially spherical.

5. The toy according to claim 1, wherein the inner cavity has an inner profile having a larger diameter than the inertial member, so that the inertial member can move freely inside the cavity.

6. The toy according to claim 5, wherein the diameter of the cavity exceeds the diameter of the inertial member by an amount ranging from 2 mm to 20 mm, preferably 3 mm to 15 mm, and particularly preferably from 6 mm to 10 mm.

7. The toy according to claim 5, wherein the diameter of the cavity exceeds the diameter of the inertial member by an amount ranging from 10% to 100%, preferably 10% to 70%, particularly preferably from 20% to 60%, and even more preferably from approximately 30% to 50%.

8. The toy according to claim 1, wherein the inertial member has a volume V1 and the cavity has an inner volume V2, and the ratio of volume V1 to V2 is in a range from 0.1 to 1.0, preferably from 0.1 to 0.6, particularly preferably from 0.2 to 0.5.

9. The toy according to claim 1, wherein the inertial member has a mass m1 and the toy has a mass m2, and the ratio of mass m1 to m2 is in a range from 0.01 to 1 preferably from 0.01 to 0.5, particularly preferably from 0.1 to 0.3 and is most preferably approximately 0.2.

10. The toy according to claim 1, wherein the cavity has an inner profile which is substantially spherical.

11. The toy according to claim 1, wherein the cavity has an inner profile which is substantially ellipsoidal.

12. The toy according to claim 1, wherein the cavity has a principal axis, and said principal axis extends substantially coaxially with a central axis of the base member.

13. The toy according to claim 1, wherein at least one rigid enclosure is arranged in and completely enclosed by the base member, and said enclosure defines the cavity.

14. The toy according to claim 1, wherein the enclosure is formed of two half-shells.

15. The toy according to claim 1, wherein ribs are formed at an inner wall enclosing the cavity.

16. The toy according to claim 1, wherein at least one love ball, is arranged in the base member, and the enclosure of the love ball defines the cavity, and the inner ball of the love ball forms the inertial member.

17. A massage toy comprising:
a substantially cylindrical base member which is made of a supple material;
an enclosure within the base member that is fully surrounded by the base member;
a cavity positioned inside the enclosure and defined by the enclosure;
a freely movable inertial member positioned inside the cavity that is defined by the enclosure.

18. The toy according to claim 17, wherein the enclosure has an outer and further including a rib that extends outward from the outer wall to provide a ridge on the outmost wall of the enclosure.

19. The use of a love ball, in particular a smartball, for integration in a base member of a dildo.

20. A method of producing a massage toy, in particular a massage toy according to claim 1, by casting at least one love ball in a silicone material to form a base member.
